(19) United States
(12) Patent Application Publication
(10) Pub. No.: US 2006/0200572 A1
(43) Pub. Date: Sep. 7, 2006

(54) Scan by data direction

(75) Inventor: Jaime Schcolnik, Alonei Aba (IL)

Correspondence Address: DR. MARK FRIEDMAN LTD.;C/o Bill Polkinghorn, 9003 Florin Way, Upper Marlboro, MD, 20772, US

(73) Assignee: Check Point Software Technologies Ltd.

(21) Appl. No.: 11/360,469

(22) Filed: Feb. 24, 2006

Related U.S. Application Data
(60) Provisional application No. 60/658,599, filed on Mar. 7, 2005.

(51) Int. Cl. G06F 15/16

(52) U.S. Cl. 709/230

(57) ABSTRACT

A method for malicious code scanning in bidirectional data traffic in one or more data connections. The connection includes data traffic between one or more computers. A single direction of flow of data traffic is specified with a rule and the data traffic is scanned solely in the single specified direction. The rule is based on the connection and a protocol command of a protocol used by the connection.

### CROSS REFERENCE TO RELATED APPLICATIONS

The present application claims benefit from U.S. provisional application 60/658,599 filed 7 Mar. 2005 by the present inventor.

### FIELD AND BACKGROUND OF THE INVENTION

The present invention relates to computer security and, more particularly, to a method for scanning for computer viruses. Specifically, the method includes virus scanning in a gateway based on both connection direction and specific steps of the protocol in use.

Network attacks include both “worm” attacks and “virus” attacks. A virus attack is performed typically during an expected transfer of executable code. The virus bearing code is attached to the executable code. Virus attacks are prevented by anti-virus software that is signature-based. Typically, anti-virus software interacts with a database of known viruses that includes virus signatures. A virus signature is typically one or more instructions or data known to be included in the code bearing the virus. Anti-virus software is used to scan executable code and search for virus' signatures during or just subsequent to transfer. A worm attack is a network attack based on sending malicious code over parts of network connections where code is not expected such as during data transfer of non-executable code, e.g. while browsing the Internet. An application, running on targeted computers receiving the code, is tricked into executing the malicious code using known weaknesses in the operating system and/or in the application running on the targeted computer.

Typically, viruses and other threats are transmitted over the Internet using TCP/IP protocol. A TCP/IP packet has a header that contains a source IP address, a source port, a destination IP address and a destination port. The IP addresses specify the two machines at each end, while the port numbers ensure that the connection between the two computers is uniquely identified. The combination of these four numbers defines a single TCP/IP connection.

Referring now to the drawings, reference is now made to FIG. 1 showing a simplified prior art data network including a wide area network (WAN) 111 attached to a local area network (LAN) 115. Many local area networks 115 are protected using a firewall installed at a gateway 101 to external network 111. Firewall 101 accepts and denies traffic between two or more network domains. In many cases there are three domains where the first domain is internal network 115 such as in a corporate organization. Outside internal network 115 is a second network domain where both the internal network and the outside world have access, sometimes known as a “demilitarized zone” or DMZ 107. The third domain is external network 111 of the outside world. Servers accessible to the outside world are put in DMZ 107. In the event that a server in DMZ 107 is compromised, internal network 115 is still safe.

FIG. 2 (prior art) illustrates a computer, for instance gateway/firewall 101, which includes a processor 201, a storage mechanism including a memory bus 207 to store information in memory 209 and a WAN interface 204 and LAN interface 205, each operatively connected to processor 201 with a peripheral bus 203. Gateway 101 further includes a data input mechanism 211, e.g. disk drive and a program storage device 213, e.g. optical disk. Data input mechanism 211 is connected to processor 201 with a peripheral bus 203. Interface to DMZ is not shown in FIG. 2. Typically, prior art malicious code scanning, e.g. virus scanning techniques are based on rules that define the source and destination of the connection to be scanned, e.g. based on IP address. Each connection includes both incoming and outgoing data, however typically only data in a single direction, e.g. incoming to an internal network, is prone to include a threat. However, prior art scanning techniques do not include a set of simple set of rules for an anti-virus scanner to match data passing in a specific direction, e.g. from the DMZ to the internal network and consequently both data directions must be scanned. Furthermore, an option is unavailable in prior art anti-virus scanning techniques for scanning data passing in a specific direction using a specific protocol in a specific direction, e.g. scan all files outgoing from the internal network using SMTP.

There is thus a need for, and it would be highly advantageous to have a method of malicious code scanning based on the connection using a simple set of rules to match data passing in a specific direction.

In SMTP, incoming files or mail messages sent from the outside to people inside the organization are passed in incoming SMTP connections, i.e. connections from external mail transfer agent (MTA) or SMTP relay servers, to the internal SMTP server. When specifying outgoing files, i.e. sent from within the network to outside recipients through SMTP or mails sent from internal users to mail accounts on external SMTP servers, the files are sent through outgoing SMTP connections, i.e. connections from the internal SMTP server to an external MTA. When SMTP is used for sending mail, the data direction is always the connection direction. When POP3 is used for getting mail from the receiving mail server to the user's mail client, the data direction is always opposed to the connection direction, since the client initiates the connection, and the data is sent as a reply from the server. In POP3 case, outgoing data means that internal users connecting from outside the network (e.g. using a virtual private network (VPN) retrieving mail from home) their mail is sent outside the network and the connection in this case is incoming. Incoming data in POP3 case means that internal users from within the network have a mail account on a POP3 server outside the network and they are connecting in order to download mail to their client in the internal network. IMAP is similar to POP3 in that IMAP also serves to retrieve mail from the receiving server.

### SUMMARY OF THE INVENTION

The term “connection” or “data connection” as used herein refers to a unique specification of data transfer between two or more computers which are operatively attached over one or more data networks. An “end-point” to a data connection as used herein refers to either an origin or a destination of data transfer. The term “session” as used herein refers to two or more related connections such as a control connection with a related data connection.

According to the present invention there is provided a method for malicious code scanning in bidirectional data traffic in one or more data connections. The connection includes data traffic between one or more computers. A single direction of flow of data traffic is specified with a rule and the data traffic is scanned solely in the single direction. The rule is preferably based on the connection and a protocol command of a protocol used by the connection. The rule is typically stored in memory, attached to a gateway between the computers. Preferably, the connection is through the gateway, and the scanning is performed by an anti-virus module at the gateway. Various protocols may be supported including hypertext transfer protocol (HTTP), file transfer protocol (FTP), Simple Mail Transfer Protocol (SMTP), Interactive Mail Access Protocol (IMAP), Post Office Protocols (e.g. POP3) or a messenger protocol. Typically, the data traffic includes a data file, and prior to the scan, the data file to undergo the scan is specified based on an end point of the data traffic. Generally, the end point is specified as a network member of an internal network or a de-militarized zone (DMZ) a member of a virtual private network or a member of the external network.

According to the present invention there is provided a system which scans malicious code. The system includes a first computer attached to a first network and a second computer attached to a second network. A data connection manages bidirectional data traffic between the computers. A user specifies a rule including a single direction of flow of the data traffic; and a scan mechanism scans the data traffic solely in the specified direction. The rule is typically based on the connection and a protocol command of a protocol used by the connection. The system supports hypertext transfer protocol (HTTP), file transfer protocol (FTP) Interactive Mail Access Protocol (IMAP), simple mail transfer protocol (SMTP), post office protocols (POP) and a messenger protocol. The data traffic includes a data file, and the scan mechanism e.g. anti-virus module, scans the data file based on an end point of the data traffic. The end point is typically a member of an internal network a de-militarized zone (DMZ), a member of a virtual private network or a member of the external network.

The rule and scan module are preferably stored in memory attached to the gateway between the first and the second networks.

According to some embodiments (e.g. FTP) of the present invention there is provided a method for malicious code scanning of data traffic between at least two computers. Providing a first connection between the computers, the first connection determines a direction of the data traffic in a second connection and the malicious code scanning is selectively performed based on the determined direction. The first and second connections may be of a single session and/or the first connection is a control session for the second connection.

According to the present invention there is provided a program storage device readable by a machine, tangibly embodying a program of instructions executable by the machine to perform methods as described herein for malicious code scanning.

### BRIEF DESCRIPTION OF THE DRAWINGS

The invention is herein described, by way of example only, with reference to the accompanying drawings, wherein:

FIG. 1 is a prior art drawing of a conventional network;

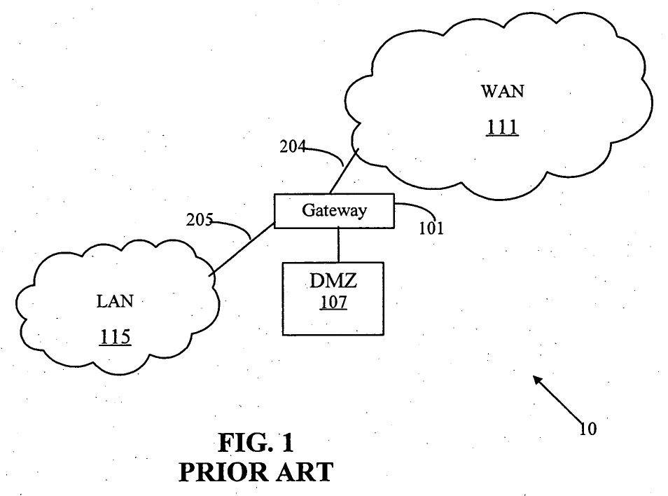

FIG. 2 is a simplified drawing of a prior art computer configured as a gateway;

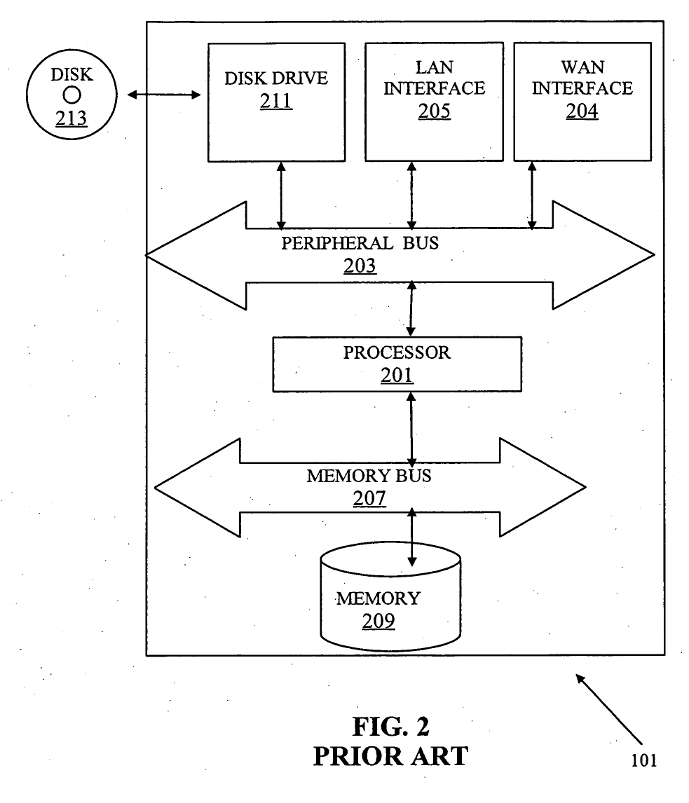

FIG. 3 is a simplified drawing showing scan by direction with HTTP protocol according to an embodiment of the present invention;

FIG. 4 is a simplified drawing showing scan by direction with FTP protocol according to an embodiment of the present invention; and

FIG. 5 is drawing of a user interface, according to an embodiment of the present invention.

### DESCRIPTION OF THE PREFERRED EMBODIMENTS

The present invention is of a system and method of malicious code scanning based on direction of data traffic in addition to the connection.

The principles and operation of a system and method of malicious code scanning based on direction of data traffic in addition to the connection, according to the present invention, may be better understood with reference to the drawings and the accompanying description.

It should be noted, that although the discussion herein relates to anti-virus scanning in a gateway between a local network and wide area network, the present invention may, by non-limiting example, alternatively be configured as well between any type or number of networks. Furthermore, the present invention may, by non-limiting example, alternatively be configured as well for malicious code scanning other than scanning for viruses. Furthermore, the scanning mechanism may be of any such mechanisms known in the art.

The present invention in different embodiments is applicable to many different protocols, including messenger protocols (e.g. Microsoft Messenger, Yahoo messenger, AOL Instant Messenger (AIM) ICQ, Yahoo-Messenger, peer-to-peer Internet telephony (VoIP) networks, (e.g. Skype, Google Talk) protocols which allow file transfer, and electronic mail protocols that use the same session to move files either to or from the client: (e.g. Interactive Mail Access Protocol (IMAP) or protocols used by Microsoft Exchange.)

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, the principal intention of the present invention is to provide an intuitive and precise method to define rules for malicious code scanning based on file direction. The present invention in different embodiments applies to a single bidirectional connection, or in the case of the two related connections. In both cases, the purpose is to scan data only in a desired direction

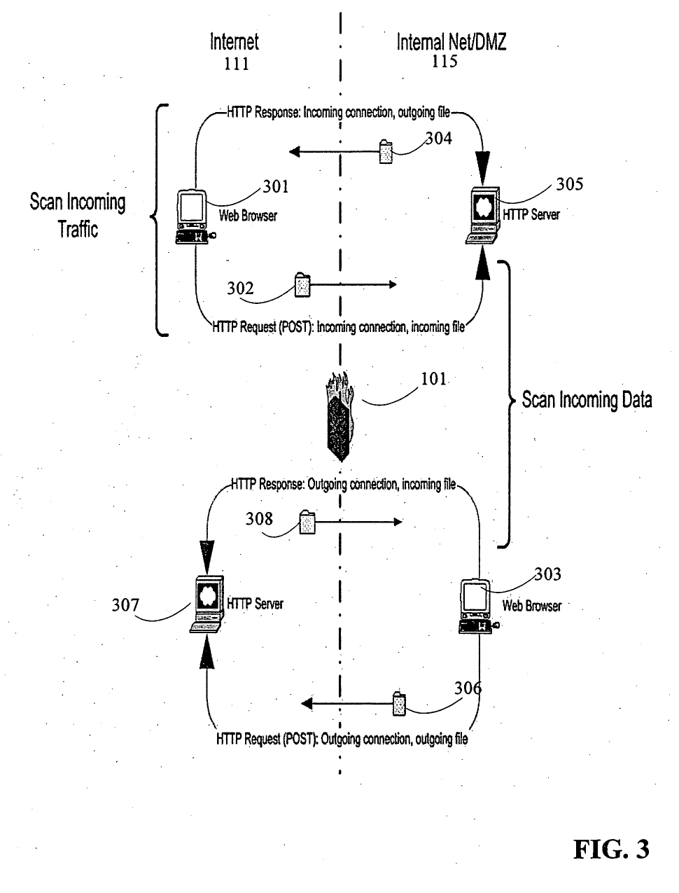

FIG. 3 illustrates an embodiment of the present invention. Web browser 301 in external network 111 places an HTTP request to an HTTP server 305 in Internal network 115 causing an incoming file 302 to Internal network 115. An HTTP response from HTTP server 305 on the same incoming connection causes an outgoing file 304 from internal network 115 to external network 111. Similarly, a Web browser 303 in internal network 115 places an HTTP request on an outgoing connection to an HTTP server 307 in external network 111, causing an outgoing file 306 to HTTP server 307. An HTTP response from HTTP server 307 on the same outgoing connection, causes an incoming file 308 to Web browser 303. Consequently, scanning incoming HTTP data as a single rule for anti-virus scanning is achieved by including information regarding the connection direction and HTTP as follows:

HTTP request; incoming connection; and

HTTP response; outgoing connection,

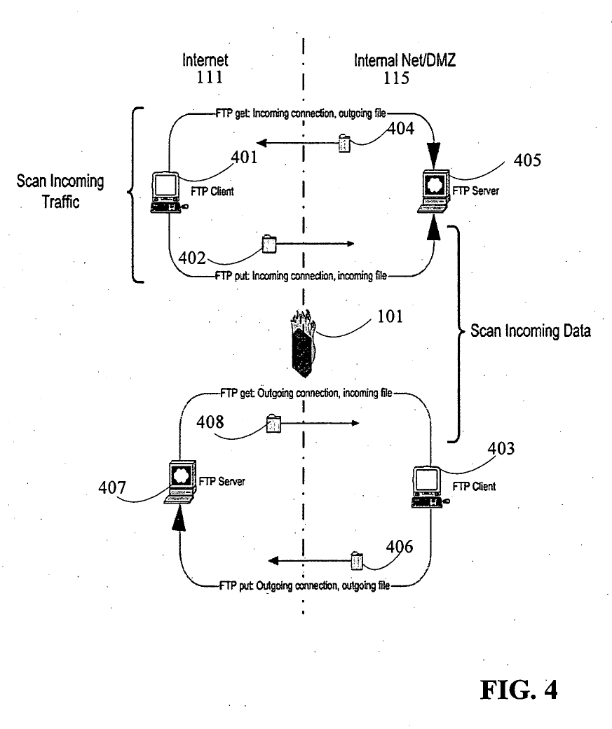

A similar configuration for FTP is shown in FIG. 4. FTP client 401 in external network 111 places an FTP PUT to an FTP server 405 in Internal network 115 causing an additional “data” connection to be opened between client 401 and server 405 in which an incoming file 402 to internal network 115 is transferred. An FTP GET from FTP client 401 opens a similar incoming “data” connection to be opened from client 401 to server 405 but this time an outgoing file 404 from internal network 115 to external network 111 is transferred in the data connection. Similarly, a FTP client 403 in internal network 115 places an FTP PUT on an outgoing connection to a FTP server 407 in external network 111, causing an outgoing file 406 to FTP server 407 on an outgoing data connection. An FTP GET from FTP client 403 opens a similar outgoing data connection, causes an incoming file 408 to FTP client 403. Consequently, scanning incoming FTP data as a single rule for anti-virus scanning is achieved by including information regarding the connection direction and FTP as follows:

FTP PUT; incoming connection; and

FTP GET; outgoing connection,

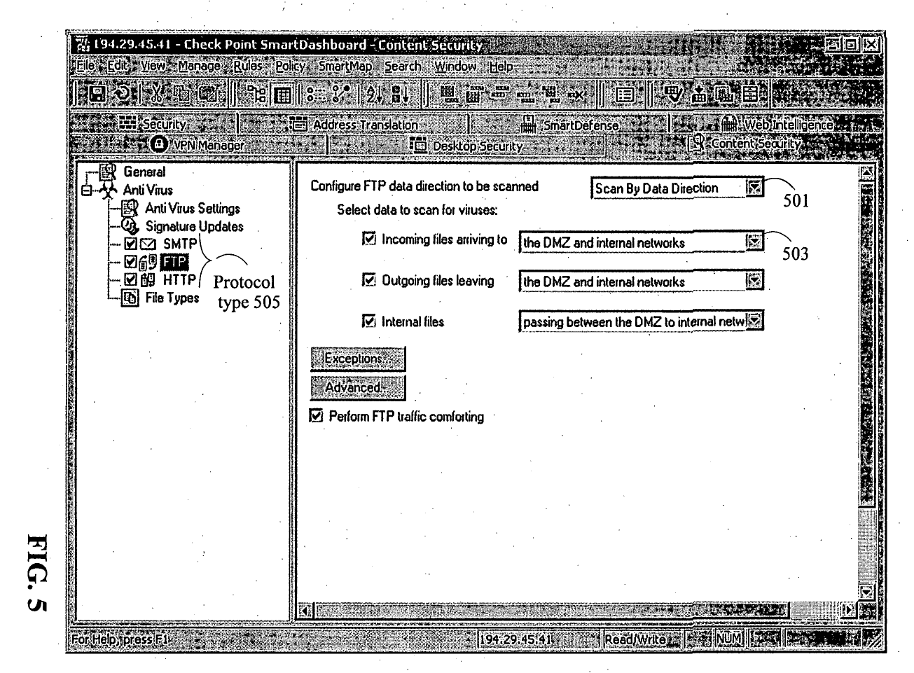

FIG. 5 illustrates a user interface according to an embodiment of the present invention. For each protocol type as shown in menu 505, the user may select an option “scan by data direction” as shown in pull down menu 501. Another pull down menu 503 is used to indicate whether incoming files to and/or outgoing files from internal network 115 and/or DMZ 107 are scanned.

In embodiments of the present invention, for some protocol sessions, the direction of file transfer is known in advance. For instance, in POP3, a client initiates an outgoing connection to a receiving mail server. A rule in the outgoing POP3 connection specifies scanning all inbound data files of the same session. Other embodiments of the present invention are applicable in different network types. For instance, when a person at home is attached to a virtual private network (VPN) from an organization, his/her incoming electronic mail messages are scanned since as far as the organization is concerned the electronic mail messages are incoming to the organization.

Therefore, the foregoing is considered as illustrative only of the principles of the invention. Accordingly, all suitable modifications and equivalents may be resorted to, falling within the scope of the invention.

While the invention has been described with respect to a limited number of embodiments, it will be appreciated that many variations, modifications and other applications of the invention may be made.

What is claimed is:

1. A method for malicious code scanning, the method comprising the steps of:
(a) providing bidirectional data traffic in a connection, wherein said connection includes data traffic between at least two computers;
(b) specifying a single direction of flow of said data traffic with a rule based on said connection and a protocol command of a protocol used by said connection; and
(c) scanning said data traffic solely in said single direction.

2. The method, according to claim 1, wherein said scanning is performed by an anti virus module.

3. The method, according to claim 1, wherein said connection is through a gateway and said scanning is performed at said gateway.

4. The method, according to claim 1, wherein said protocol is selected from the group of protocols consisting of a hypertext transfer protocol (HTTP), a file transfer protocol (FTP), a simple mail transfer protocol (SMTP), a post office protocols (POP), an Interactive Mail Access Protocol (IMAP), and a messenger protocol.

5. The method, according to claim 1, wherein said data traffic includes a data file, further comprising the step of, prior to said scanning:
(d) specifying said data file to undergo said scanning based on at least one end point of said data traffic.

6. The method, according to claim 1, further comprising the step of,
(d) storing said rule in a memory operatively attached to a gateway between said at least two computers.

7. The method, according to claim 5, wherein said at least one end point is a member of a network selected from the group consisting of an internal network, a de-militarized zone (DMZ) and an external network.

8. The method, according to claim 5, wherein said at least one end point is a member of a virtual-private-network.

9. A system which scans malicious code, the system comprising:
(a) a first computer operatively attached to a first network and a second computer operatively attached to a second network;
(b) a data connection which manages bidirectional data traffic between said first and second computers;
(c) a rule wherein a user specifies a single direction of flow of said data traffic; and
(d) a scan mechanism which scans said data traffic solely in said single direction.

10. The system, according to claim 9, wherein said rule is based on said connection and a protocol command of a protocol used by said connection.

11. The system, according to claim 9, wherein said protocol is selected from the group of protocols hypertext transfer protocol (HTTP), file transfer protocol (FTP) Interactive Mail Access Protocol (IMAP), simple mail transfer protocol (SMTP), a post office protocol (POP) and a messenger protocol.

12. The system, according to claim 9, wherein said data traffic includes a data file, wherein said scan mechanism scans said data file based on at least one end point of said data traffic.

13. The system, according to claim 12, wherein said user specifies said at least one end point is a member of a network selected from the group consisting of an internal network a de-militarized zone (DMZ) and an external network.

14. The system, according to claim 12, wherein said user specifies said at least one end point is a member of a virtual private network.

15. The system, according to claim 9, wherein said scan mechanism is installed in a gateway between said first and said second network.

16. A program storage device readable by a machine, tangibly embodying a program of instructions executable by the machine to perform a method for malicious code scanning, the method comprising the steps of:
(a) providing bidirectional data traffic in a connection, wherein said connection includes data traffic between at least two computers;
(b) specifying a single direction of flow of said data traffic with a rule based on said connection and a protocol command of a protocol used by said connection; and
(c) scanning said data traffic solely in said single direction.

17. A method for malicious code scanning of data traffic between at least two computers, the method comprising the steps of:
(a) providing a first connection between the at least two computers;
(b) said first connection determining a direction of the data traffic in a second connection; and
(c) selectively performing the malicious code scanning based on said direction.

18. The method, according to claim 17, wherein said first connection and said second connection are of a single session.

19. The method, according to claim 17, wherein said first connection is a control connection.

20. A program storage device readable by a machine, tangibly embodying a program of instructions executable by the machine to perform a method for malicious code scanning, the method according to claim 17.
